(19) United States
(12) Patent Application Publication
(10) Pub. No.: US 2008/0123895 A1
(43) Pub. Date: May 29, 2008

(54) METHOD AND SYSTEM FOR FAST VOLUME CROPPING OF THREE-DIMENSIONAL IMAGE DATA

(76) Inventors: Todd Gable, Newark, CA (US); Matthew Merzbacher, Oakland, CA (US)

Correspondence Address: GENERAL ELECTRIC CO.;GLOBAL PATENT OPERATION, 187 Danbury Road, Suite 204, Wilton, CT, 06897-4122, US

(21) Appl. No.: 11/563,511

(22) Filed: Nov. 27, 2006

(51) Int. Cl. G06K 9/00; G06T 17/00

(52) U.S. Cl. 382/100; 345/424; 382/132

(57) ABSTRACT

A method for quickly identifying object volumetric data and air volumetric data from image data of an object is disclosed. Significantly, embodiments of the method result in significant savings in disk space and a significant reduction in computer processing time as compared to the types of known three-dimensional image processing methods described above. An explosive detection system is also provided that includes computer executable instructions stored in a memory coupled with a computer processor. When executed by the computer processor, the computer executable instructions cause the computer processor to: operate the imaging system to obtain the image data of the object; sample the image data in three dimensions; identify one or more candidate voxels; and identify, from the one or more candidate voxels, one or more starting voxels.

### BACKGROUND

1. Field of the Invention

The technology disclosed herein relates to methods of operating explosive detection systems and medical imaging systems generally, and more particularly, to a method and system for fast volume cropping of air volumetric data from image data of an object.

2. Discussion of Related Art

Various government agencies throughout the world are responsible for quickly and accurately identifying contraband and/or dangerous materials within passenger baggage in ways that minimize passenger inconvenience and travel times. Countless x-ray baggage scanning systems used by such agencies are of the “line scanner” type. This type of x-ray baggage scanning system includes a conveyor belt, a stationary x-ray source, and a stationary linear detector array. The conveyor belt transports a bag (e.g., a single piece of passenger baggage), through the scanner and between the stationary x-ray source and the stationary detector array. The x-ray source produces an x-ray beam. As the bag moves into the x-ray beam, the beam passes through and is partially attenuated by the bag, before being received by the detector array. Each two-dimensional region of the baggage through which the x-rays penetrate forms a planar segment (“slice”) having a unique density of x-rays that varies depending on how much attenuation the baggage affords. Each time the x-ray source activates, each detector of the detector array records projection data, which is conventionally calculated as the integral of the density of each planar segment of the baggage. Once obtained, the projection data is processed by a computer and used to reconstruct a two-dimensional density image of the baggage. Customarily, the two-dimensional density image of the baggage is displayed for analysis by a human operator.

Other types of x-ray baggage scanning systems use various types of x-ray computed tomography (CT) to identify objects within baggage that is conveyed through the scanning system. Manufacturers of x-ray CT scanning systems include GE Homeland Protection, Inc. (formerly InVision, Inc.) of Newark, Calif., which is a subsidiary of the General Electric Company, and International Security Systems Corporation, which is a subsidiary of Analogic Corporation.

One example of a conventional CT scanner is a dual-energy, helical cone beam, multi-slice CT scanner, developed by Analogic, Inc., which can generate 3-D image data of all objects in a bag, collect all image data in one pass, automatically analyze the entire contents of the bag, and scan up to six hundred bags per hour. In such a CT system, sophisticated software can automatically isolate, analyze, and evaluate bag contents against the known characteristics of explosives, illegal drugs, and other contraband. If a match is found, the CT scanning system operator is notified, the area of concern is highlighted, and/or a full rotating three-dimensional image of the potential threat is provided for further analysis.

Additionally, explosive detection systems that integrate multiple types of scanning systems have been developed. One example is an advanced technology explosive detection system developed by GE Homeland Protection, Inc. (formerly InVision, Inc.) of Newark, Calif., which is a subsidiary of the General Electric Company that combines a coherent x-ray scatter (CXRS) scanner with a CT scanner and offers data-fusion between the scanners for baggage screening. When used in the scanner-fused explosive detection system, the CXRS scanner uses alarm location data, acquired by the CT scanner positioned earlier in the baggage handling system, to limit the CXRS scan to specific areas of bags that the CT scanner previously identified as suspicious. CXRS uses molecular composition to identify alarm objects, and is used in combination with x-ray CT to lower false alarm rates and improve baggage throughput.

Although x-ray CT scanners are useful, their current methods of operation share a common disadvantage, which is that a significant portion of the image volumetric data obtained by the x-ray CT scanner consists of air volumetric data that borders object volumetric data (e.g., a bag, clothing, shoe, etc.). This is natural since the cross-sectional diameter of the object of interest is typically smaller than the diameter of the rotatable gantry that forms part of a conventional x-ray CT scanner. Various methods have been proposed to solve this problem, but are undesirable due to the immense amounts of raw computer processing power and scan times required. One such method utilizes per-voxel iteration through all of the image data. Another method moves slices in from the edges of the image data and searches them for voxel values that exceed a pre-determined threshold. Another method uses a multi-dimensional bisection approach. Yet another method uses a ray-casting approach. A drawback of such methods is that digital image processing in three dimensions (3D) using such methods is computationally expensive. Moreover, processing the significant amounts of air volumetric data associated with such methods is wasteful and time-consuming for high-volume imaging systems.

A solution is thus needed that provides a method, applicable to x-ray CT scanners, and other imaging systems, that minimizes the number of voxels to be analyzed in the image data of an object (e.g., a bag, a medical patient, a product, etc.). It is further desired that such a solution be easily implemented in existing imaging systems used in security, medical, engineering, and other types of applications. Such a solution can yield reduced processing times for passenger baggage, medical patients, product inspection/testing, etc., offering the potential for reduced operating costs.

### BRIEF DESCRIPTION

Embodiments of the invention overcome the disadvantages associated with the related art and meet the needs discussed above by providing a novel method and system for identifying, cropping, and (optionally) discarding air volumetric data from around volumetric object data in image data obtained by an x-ray CT scanner or other imaging device. Such a method is relatively simple, cost-effective, and efficient. It also significantly lessens the amount of computer processing required and reduces scan times by focusing the subsequent imaging and/or threat detection analysis on only the volumetric object data that remains after the air volumetric data has been quickly identified and cropped. Embodiments of the novel method are suitable for use in security applications, medical applications, engineering applications, etc. It also is more efficient for network transmissions and disk storage.

Technical effects afforded by embodiments of the invention include, but are not limited to, air volumetric data cropped from image data of an object; a substantial reduction in the time it takes to process the object volumetric data that remains after the air volumetric data is cropped; and a substantial increase in disk space savings, as compared to prior image processing methods and systems. The significant improvements in processing time and disk space savings result, in part, from quickly locating the boundaries of the imaged object, and from storing and processing the object volumetric data together with minimal or no air volumetric data.

In some embodiments, a method is provided. The method may comprise obtaining image data of an object from an imaging system, wherein the image data comprises air volumetric data and object volumetric data. The method may further include a step of sampling the image data in three dimensions. The method may further include a step of identifying one or more candidate voxels; and a step of identifying, from the one or more candidate voxels, one or more starting voxels.

As an alternative to the above-described embodiments, a system is provided. The system may be an explosive detection system, a medical imaging system, or an engineering imaging system. An embodiment of the system may comprise an imaging system configured to obtain image data of an object. The image data comprises air volumetric data and object volumetric data. The system may further comprise a computer processor coupled with the imaging system, and a memory readable by the computer processor. Computer executable instructions stored in the memory may also form part of the explosive detection system. When executed by the computer processor, the computer executable instructions cause the computer processor to: operate the imaging system to obtain the image data of the object; sample the image data in three dimensions; identify one or more candidate voxels; and identify, from the one or more candidate voxels, one or more starting voxels.

The foregoing has outlined rather broadly the features of the invention so that the following detailed description may be better understood. Additional features and advantages of various embodiments of the invention that form the subject matter of the appended claims may be described hereinafter.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram of an object entering a scanning area of an imaging system, according to an embodiment of the invention;

FIG. 2 is a diagram illustrating an embodiment of three-dimensional x-ray image data that contains object volumetric data surrounded by air volumetric data;

FIG. 3 (subdivided into FIGS. 3A, 3B, 3C, and 3D) is a flowchart of an embodiment of a method of fast volume cropping air volumetric data from x-ray image data of an object;

FIG. 4 is an exploded, perspective view of six data slices that form a bounding box within x-ray image data of an object, according to an embodiment of the invention;

FIG. 5 a top view of the x-ray image data of FIG. 4, according to an embodiment of the invention; and

FIGS. 6, 7, 8, 9, 10, and 11 are top views of another embodiment of x-ray image data of an object.

### DETAILED DESCRIPTION

Reference is made herein to the accompanying drawings briefly described above, which show by way of illustration various embodiments of the invention. Persons of ordinary skill in the above-referenced technological field will recognize that other embodiments may be utilized, and that various changes may be made without departing from the scope of the claimed invention.

As used herein, an element or step recited in the singular and proceeded with the word “a” or “an” includes plural elements or steps, unless exclusion of such plural elements or steps is explicitly recited.

The following terms (alarm object, bag, baggage, imaging system, object, image data, reconstructing an image, image reconstruction, object volumetric data, air volumetric data, crop, bounding box, and sampling) used herein should generally be construed as having the following exemplary meanings. As used herein the term:

“alarm object” refers to any substance or thing that has been designated for detection by an inspection system (non-limiting examples include explosives, illegal drugs, hazardous substances, tissue anomalies, product components, and the like);

“bag” refers to a piece of baggage;

“baggage” refers to all of a passenger's or traveler's personal belongings, whether checked or unchecked;

“imaging system” refers to a device that analyzes an object and converts analog information about the object into digital data.

“object” refers to anything that can be imaged by a scanner (Non-limiting examples of an “object” include all or portions of a bag, a medical patient, a commercial product, etc.);

“image data” refers to all the converted digital data (whether in viewable or non-viewable form) that corresponds to the analog information about the scanned object, and includes both object volumetric data and air volumetric data;

“object volumetric data” refers to three-dimensional digital data that corresponds to the object itself,

“air volumetric data” refers to three-dimensional digital data that corresponds to the air surrounding the object;

“crop” refers to removing unwanted parts (e.g., air volumetric data) from image data;

“bounding box” refers to a closed volume that contains all, or substantially all (e.g., greater than about 95% of), the object volumetric data (In some embodiments, inner surfaces of the closed volume may define or approximate the three-dimensional outer surfaces of the object);

“sampling” refers to selecting a subset of image data voxels for comparison to a predetermined voxel threshold; and

“voxel threshold” refers to a scan setting that determines a point at which a voxel will be categorized as an “air voxel” or an “object voxel” depending upon its scanned color and/or density value.

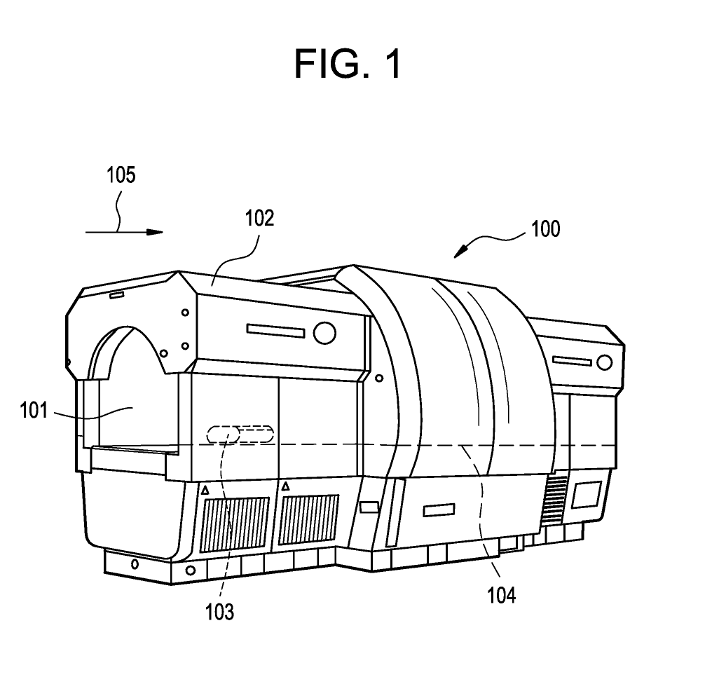

FIG. 1 is a diagram of an object 103 entering a scanning area 101 of an imaging system 102, which may form part of an integrated, automated explosive detection system 100 that is configured according to an embodiment of the invention. As further described below, the explosive detection system 100 and/or the imaging system 102 may be controlled by a computer system. In an embodiment, the object 103 is moved in the direction of arrow 105 through the explosive detection system 100 via a conveyor belt 104 that extends from one end of the explosive detection system 100 to the other. The explosive detection system 100 may be integrated with an airport baggage handling system and/or an airport security system. In an embodiment, the imaging system 102 is an x-ray CT scanner. In other embodiments, the imaging system 102 may include a different type of scanner such as an x-ray diffraction (XRD) scanner and a coherent x-ray scatter (CXRS) scanner, among others.

Although medical and engineering embodiments are not depicted in the Figures, the imaging system 102 may be an x ray CT scanner configured for use in medical or engineering applications. In medical applications, the object that is scanned may be a medical patient (or a portion thereof), and the alarm object may be a tissue irregularity such as a blood clot, a tumor, and the like. In engineering applications, the object may be a manufactured product (or portion thereof) that is being tested and/or reverse engineered. In an embodiment directed to medical applications, the imaging system 102 may be a magnetic resonance imaging (MRI) scanner, or other type of medical imaging system.

In the embodiment shown in FIG. 1, the object 103 is illustratively depicted as a bag. In other embodiments, the object 103 may be a shoe, an article of clothing, a medical patient, a commercial product, etc.

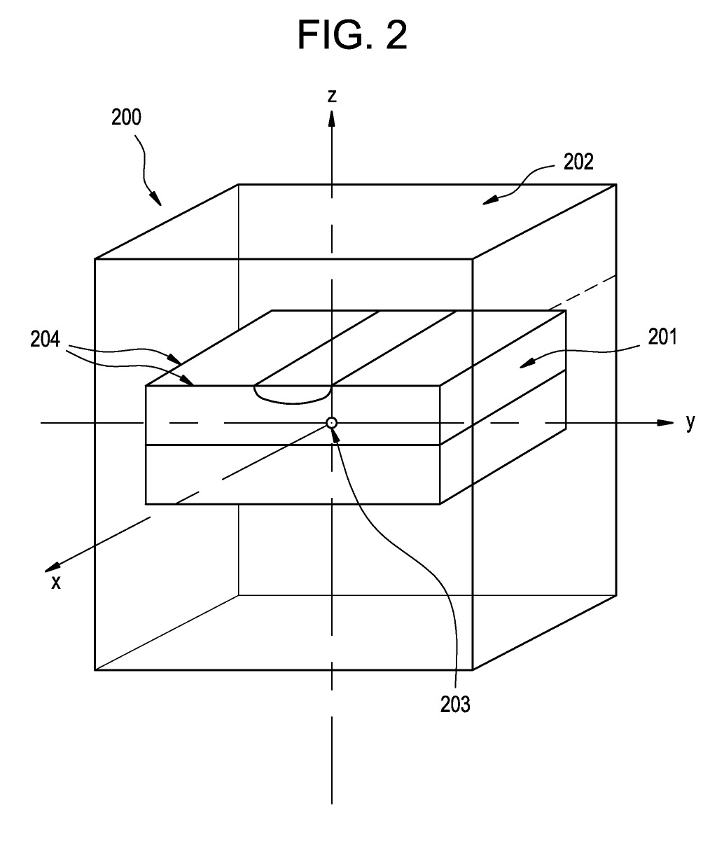

FIG. 2 is a diagram that provides an illustrative visual representation of image data 200 resulting from the scanning of the object 103 of FIG. 1. It will be appreciated that in an embodiment of the invention, the image data 200 may be non-viewable (e.g., stored only in a computer readable memory and not displayed for viewing by a human operator of the imaging system 102) during acquisition, during one or more image processing steps, and/or during one or more image analysis steps. The image data 200 illustratively shown in FIG. 2 may be derived by reconstructing scan projection data obtained from x-ray scanning of the object 100 by the imaging system 102. As shown, the image data 200 comprises two parts: object volumetric data 201 and air volumetric data 202, each comprised of one or more voxels (e.g., three-dimensional digital data). Each of the voxels comprising the object volumetric data 201 and the air volumetric data 202 has a unique value (color, intensity, etc.) associated with it. When compared with a predetermined voxel threshold, as further described below, these unique voxel values may be used to distinguish air voxels from object voxels. By way of example, the center of the scanner field-of-view 101 may be used as an origin 203 of a three dimensional frame of reference having a Z-axis orthogonal to an X-Y plane. As further described below, a bounding box 204 that defines or approximates the limits of the object volumetric data 201 may be used to attain the object volumetric data 201 for further analysis and processing.

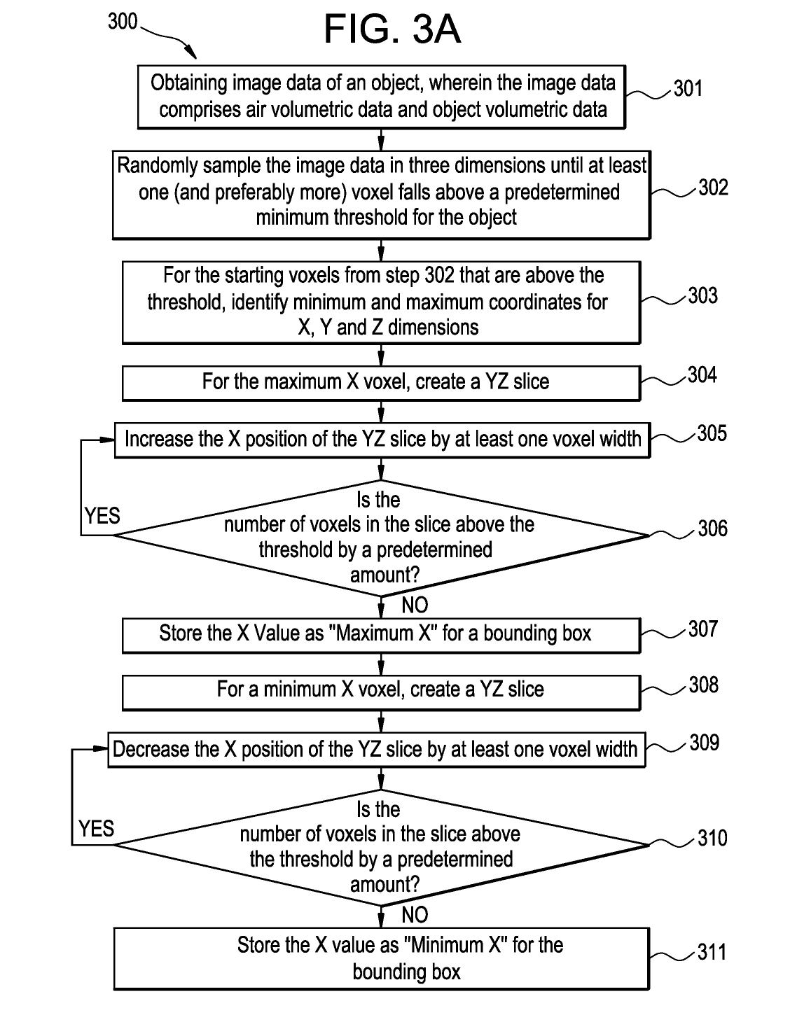

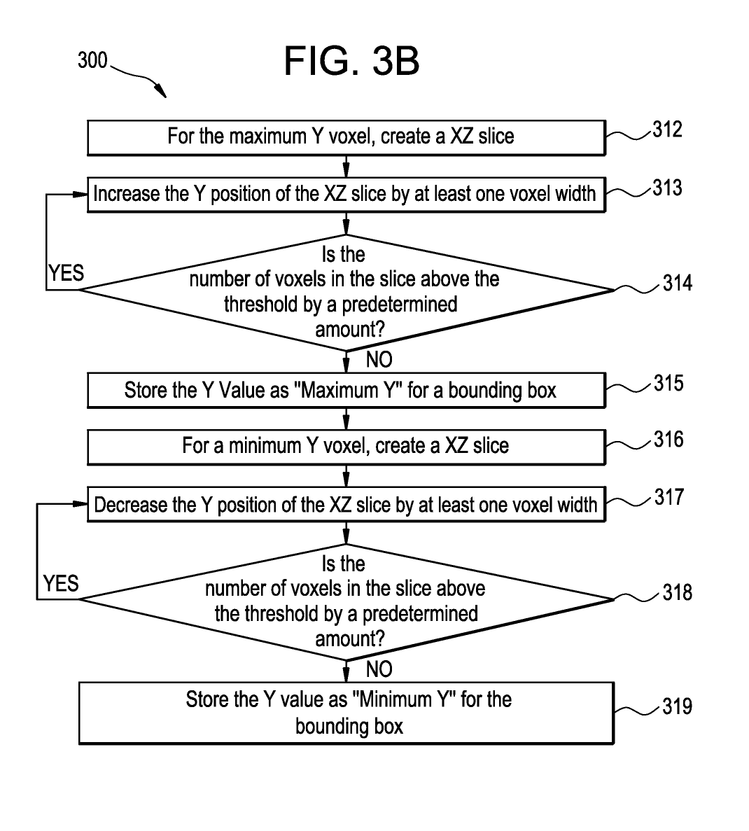

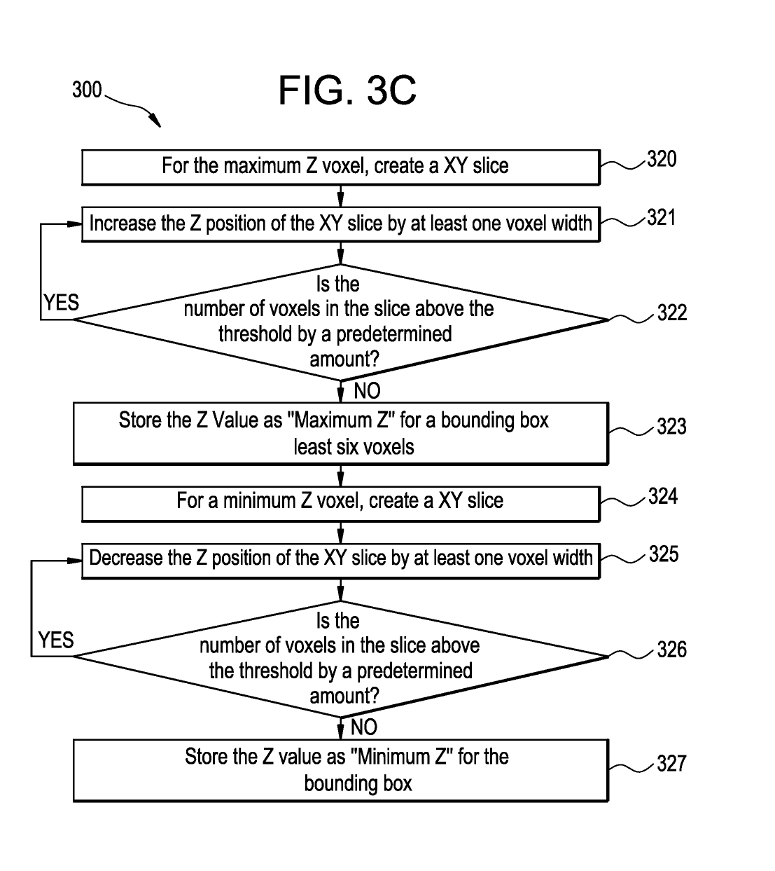

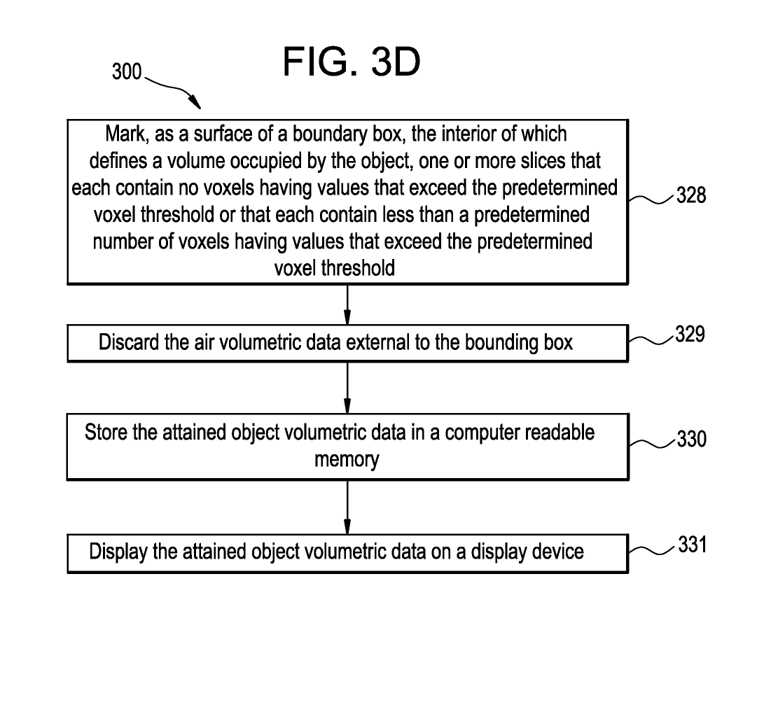

FIG. 3 (subdivided into parts 3A, 3B, 3C, and 3D) is a flowchart illustrating an embodiment of a method 300 for fast volume cropping of image data that corresponds to a scanned object. It will be appreciated that the steps of the method 300 may be performed in any suitable order, and that one or more of the steps of the method 300 may include one or more additional substeps.

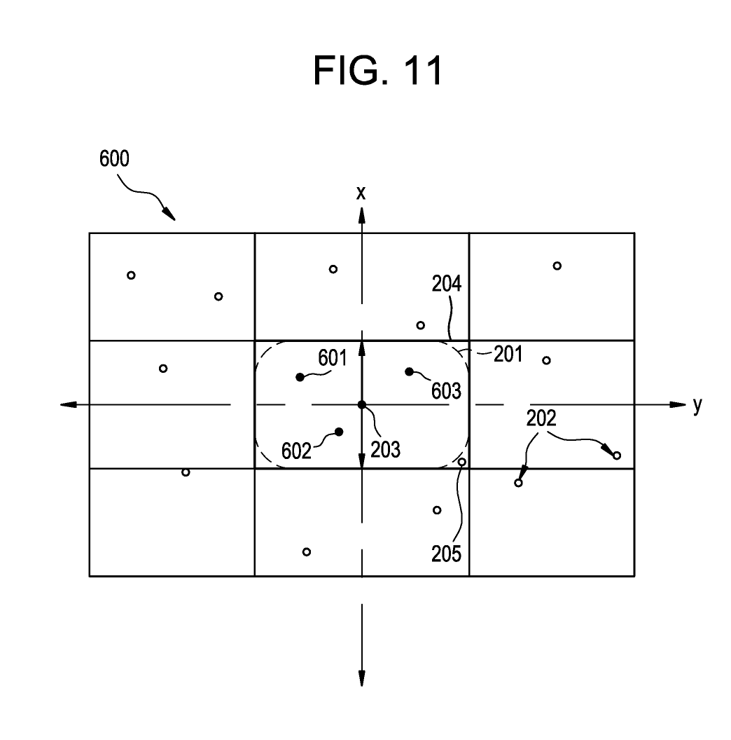

Referring to FIG. 3A, the method 300 may include a step 301 of acquiring image data of an object. In a non-limiting embodiment, the image data may be acquired by an imaging apparatus such as, but not limited to, an x-ray scanner of the type commonly used in medical, engineering, or security applications. The object may be any item capable of being imaged by x-ray. Non-limiting examples of an object include a piece of baggage, a manufactured product to be tested and/or reverse-engineered, and a medical patient, among others. Depending on what type of imaging apparatus is used, air may border the object and/or separate the object from the x-ray source and/or the x-ray detector. If so, the resulting x-ray image data will include both object volumetric data (e.g., three-dimensional data associated with the object) and air volumetric data (e.g., three-dimensional data associated with the air that borders the object. As discussed in more detail below with respect to other steps comprising the method 300 and also with respect to FIG. 11, a large percentage of the air volumetric data can be quickly identified and cropped by embodiments of the invention to increase the speed at which image processing occurs.

The method 300 may further include a step 302 of sampling the image data in at least one dimension (and preferably two or more dimensions) until at least one voxel (and preferably more voxels) fall above a predetermined minimum voxel threshold that has been selected to distinguish object voxels from air voxels. In an optional embodiment, the sampling of the image data in three dimensions may occur randomly. A voxel that falls above the predetermined minimum voxel threshold may hereinafter be referred to as “a candidate voxel.” The maximum and minimum (in X, Y, and Z, respectively) candidate voxels may hereinafter be referred to as “starting voxels” since they are used, in one embodiment of the invention, as starting points for a voxel-by-voxel iteration of a slice in at least one of the positive and negative X, Y, and Z dimensions. It will be appreciated that this predetermined minimum voxel threshold will vary depending upon the type of object imaged, the type of imaging apparatus used, and the like. In an embodiment, a step of identifying one or more candidate voxels may include comparing values of voxels that comprise the sampled image data with the predetermined voxel threshold.

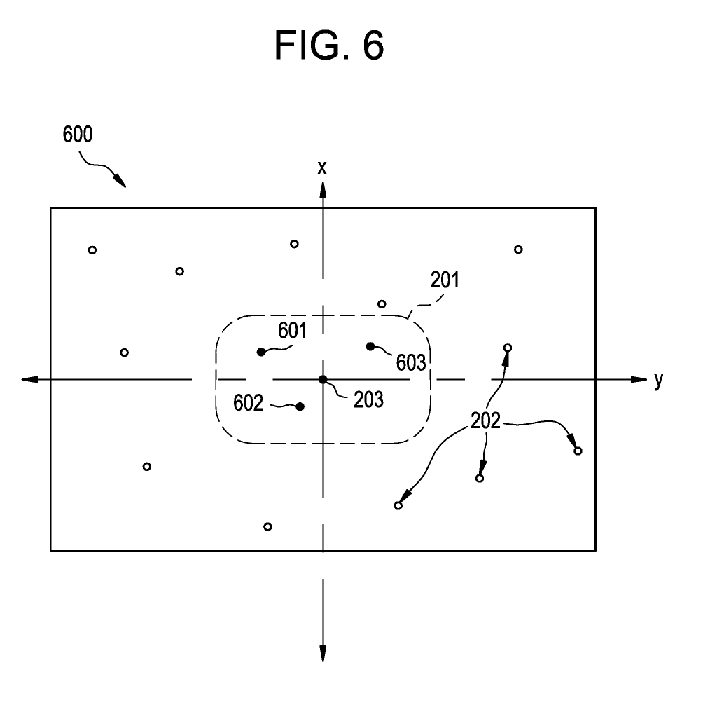

The method 300 may further include a step 303 of identifying, for the one or more starting voxels from step 302 that are above the predetermined voxel threshold, a minimum and a maximum X, Y, and Z coordinate. In other words, the method 300 may identify each of the one or more starting voxels based on at least one of a maximum and minimum coordinate in three dimensions. Embodiments of steps 301, 302, 303 are further described below with respect to FIGS. 6, 7, and 9.

Referring again to FIG. 3A, the method 300 may further include creating at least one slice through at least one of the one or more starting voxels, wherein the at least one slice is orthogonal to a coordinate selection axis of the at least one of the one or more starting voxels. This is illustrated in FIG. 3A by step 304 of creating, for a maximum X voxel, a YZ slice that passes through the maximum X voxel. In this example, the YZ slice is orthogonal to the X axis, which is the coordinate selection axis of a starting voxel, illustratively referred to above as “a maximum X” voxel. The method 300 may further include a step 305 of increasing the X position of the YZ slice by at least one voxel-width(in the positive X direction). In one embodiment, the amount of iteration is one voxel-width, In alternative embodiments, the amount of iteration could be any amount (e.g., two or more voxel-widths) and could even vary from iteration to iteration. The method 300 may further include a step 306 of determining whether the number of voxels in the iterated YZ slice that are above the predetermined voxel threshold exceed a predetermined amount. If yes, the method 300 loops back to step 305, and the YZ slice is iterated, voxel-width by -voxel-width, until the number of voxels in the iterated YZ slice that are above the predetermined voxel threshold do not exceed the predetermined amount. At step 307, an X value of this last YZ slice is stored in a computer readable medium as a “Maximum X” value for a bounding box.

The method 300 may further include a step 308 of creating, for a minimum X voxel, a YZ slice that passes through the minimum X voxel. The method 300 may further include a step 309 of decreasing the X position of the YZ slice by at least one voxel-width (in the negative X direction). The method 300 may further include a step 310 of determining whether the number of voxels in the iterated YZ slice that are above the predetermined voxel threshold exceed a predetermined amount. If yes, the method 300 loops back to step 309, and the YZ slice is iterated, voxel-by-voxel, until the number of voxels in the iterated YZ slice that are above the predetermined voxel threshold do not exceed the predetermined amount. At step 311, an X value of this last YZ slice is stored in a computer readable medium as a “Minimum X” value for the bounding box.

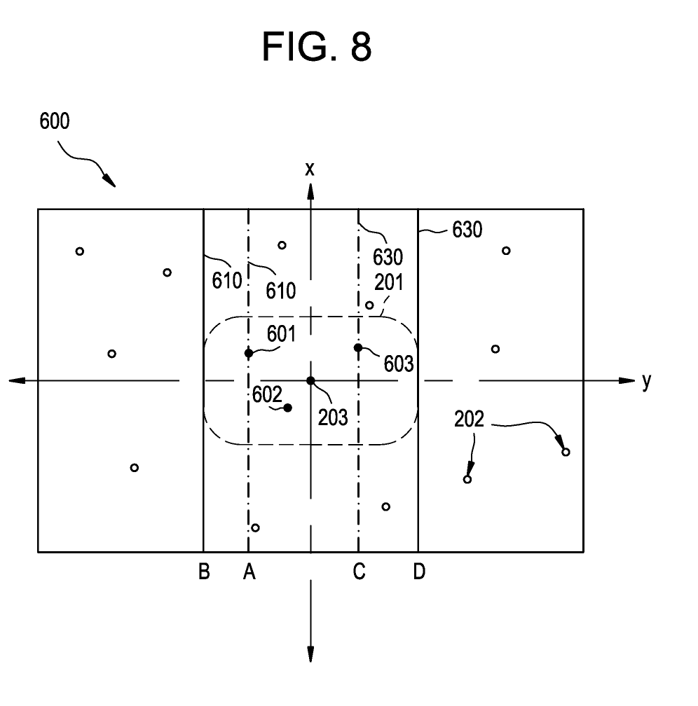

Embodiments of steps 304 to 311 are further described below with respect to FIGS. 8 and 11.

Referring to FIG. 3B, the method 300 may further include a step 312 of creating, for a maximum Y voxel, a XZ slice that passes through the maximum Y voxel. The method 300 may further include a step 313 of increasing the Y position of the XZ slice by at least one voxel width (in the positive Y direction). The method 300 may further include a step 314 of determining whether the number of voxels in the iterated XZ slice that are above the predetermined voxel threshold exceed a predetermined amount. If yes, the method 300 loops back to step 313, and the XZ slice is iterated, voxel-by-voxel, until the number of voxels in the iterated XZ slice that are above the predetermined voxel threshold do not exceed the predetermined amount. At step 315, a Y value of this last XZ slice is stored in a computer readable medium as a “Maximum Y” value for the bounding box.

The method 300 may further include a step 316 of creating, for a minimum Y voxel, a XZ slice that passes through the minimum Y voxel. The method 300 may further include a step 317 of decreasing the Y position of the XZ slice by at least one voxel width (in the negative Y direction). The method 300 may further include a step 318 of determining whether the number of voxels in the iterated XZ slice that are above the predetermined voxel threshold exceed a predetermined amount. If yes, the method 300 loops back to step 316, and the XZ slice is iterated, voxel-by-voxel, until the number of voxels in the iterated XZ slice that are above the predetermined voxel threshold do not exceed the predetermined amount. At step 319, a Y value of this last XZ slice is stored in a computer readable medium as a “Minimum Y” value for the bounding box.

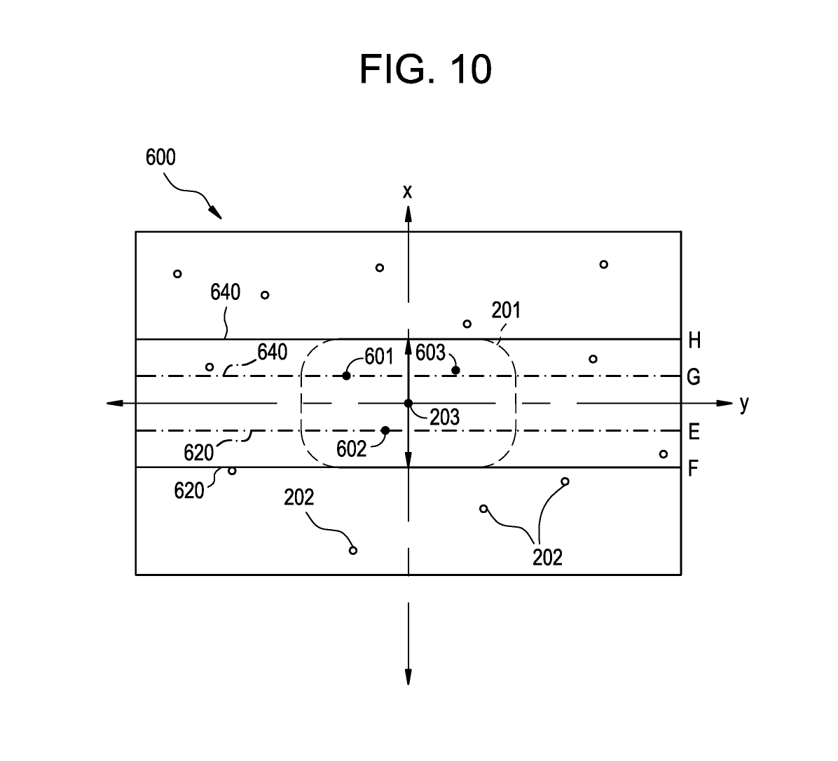

Embodiments of steps 312 to 319 are further described below with respect to FIGS. 10 and 11.

Referring to FIG. 3C, the method 300 may further include a step 320 of creating, for a maximum Z voxel, a XY slice that passes through the maximum Z voxel. The method 300 may further include a step 321 of increasing the Z position of the XY slice by at least one voxel width (in the positive Z direction). The method 300 may further include a step 322 of determining whether the number of voxels in the iterated XY slice that are above the predetermined voxel threshold exceed a predetermined amount. If yes, the method 300 loops back to step 321, and the XY slice is iterated, voxel-by-voxel, until the number of voxels in the iterated XY slice that are above the predetermined voxel threshold do not exceed the predetermined amount. At step 323, a Z value of this last XY slice is stored in a computer readable medium as a “Maximum Z” value for the bounding box.

The method 300 may further include a step 324 of creating, for a minimum Z voxel, a XY slice that passes through the minimum Z voxel. The method 300 may further include a step 325 of decreasing the Z position of the XY slice by at least one voxel width (in the negative Z direction). The method 300 may further include a step 326 of determining whether the number of voxels in the iterated XY slice that are above the predetermined voxel threshold exceed a predetermined amount. If yes, the method 300 loops back to step 325, and the XY slice is iterated, voxel-by-voxel, until the number of voxels in the iterated XY slice that are above the predetermined voxel threshold do not exceed the predetermined amount. At step 327, a Z value of this last XY slice is stored in a computer readable medium as a “Minimum Z” value for the bounding box.

Referring to FIG. 3D, the method 300 may further include a step 328 of marking, as a surface of a bounding box, the interior of which defines a volume occupied by the object, six slices (two YZ slices, two XZ slices, and two XY slices) that contain no voxels having values that exceed the predetermined voxel threshold or that contains less than a predetermined number of voxels having values that exceed the predetermined voxel threshold. After at least one slice has been marked as a surface of the bounding box, the method 300 may further include an optional step 329 of discarding the air volumetric data that falls outside the limits of the bounding box. In an alternative embodiment, the air volumetric data that falls outside the limits of the bounding box may be stored, and/or cropped in increments, rather than discarded.

The method 300 may further include a step 330 of storing the object volumetric data (and/or a small amount of air volumetric data, if any, that falls within the limits of the bounding box) that remains after step 329 in a computer readable memory. Optionally, the method 300 may include a step 331 of displaying the attained object volumetric data on a display device. In an alternative embodiment, the method 300 may optionally include a step of processing the object volumetric data within the bounding box for a presence of an alarm object. In another embodiment, the method 300 may optionally include a step of providing the object volumetric data within the bounding box for further processing, such as, but not limited to, explosives detection.

In an embodiment, one or more steps of the method 300 are implemented in a computer processor and associated memory elements within a medical, engineering, or security imaging system, for example, within the integrated explosive detection system 103 of FIG. 1. In such an embodiment the FIG. 3 steps represent program code stored in the memory element and operable in the computer processor. When implemented in a computer processor, program code configures the computer processor to create logical and arithmetic operations to process the flow chart steps. Embodiments of the invention may also be embodied in the form of computer program code written in any of the known computer languages containing instructions embodied in tangible media such as floppy diskettes, CD-ROM's, hard drives, DVD's, removable media or any other computer-readable storage medium. Embodiments of the invention can also be embodied in the form of a computer program code, for example, whether stored in a storage medium loaded into and/or executed by a computer or transmitted over a transmission medium, such as over electrical wiring or cabling, through fiber optics, or via electromagnetic radiation. When the program code is loaded into and executed by a general purpose or a special purpose computer, the computer becomes an apparatus for practicing embodiments of the invention. When the computer is integrated as part of another machine, the machine and computer become a system for practicing embodiments of the invention.

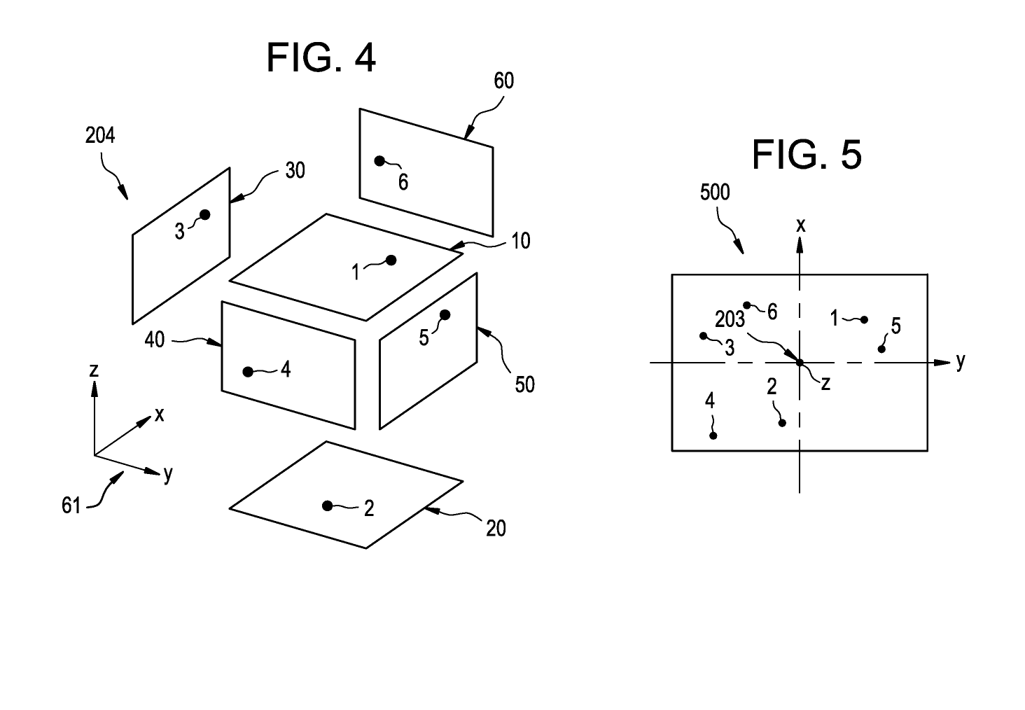

FIG. 4 is an exploded, perspective view of six slices 10, 20, 30, 40, 50, and 60 that comprise a bounding box 204, according to one embodiment of the invention. In FIG. 4, each of the six slices 10, 20, 30, 40, 50, and 60 are oriented in three-dimensional space, as indicated by the x, y, and z axes 61. FIG. 5 is a top view 500 of the image data of FIG. 4 showing the orientation of the voxels 1, 2, 3, 4, 5, and 6 of FIG. 4 in the X-Y plane.

Referring to FIGS. 4 and 5, each of the six slices 10, 20, 30, 40, 50, and 60 pass through one or more voxels 1, 2, 3, 4, 5 and 6, respectively, whose values exceeded a predetermined voxel threshold during a sampling step of the above-described method 300. Referring to FIG. 5, each of the voxels 1, 2, 3, 4, 5, and 6 is selected as being the furthest from an origin 203. Although illustratively depicted in the figures as being positioned to coincide with the coordinates of a scanner's field of view (alternatively, with the coordinates of an object's center-of-mass), the origin 203 may, in alternate embodiments, be positioned at any desired point on or within the boundaries of the object. In the embodiment represented by FIGS. 4 and 5, voxels 1 and 2 are furthest from the origin 203 along the Z axis; voxels 3 and 5 are furthest from the origin 203 along the Y axis; and voxels 4 and 6 are furthest from the origin 203 along the X axis.

FIGS. 6, 7, 8, 9, 10, and 11 are diagrams 600 of a top view of another embodiment of image data that illustrate locations of object voxels and air voxels within an X-Y plane. In FIGS. 6, 7, 8, 9, 10, and 11, each of diagrams 600 of have orthogonal X and Y axes having their origin 203 located, by way of example, at a predetermined point within the object volumetric data 201.

Referring to FIG. 6, a sampled x-ray image 600 of an object includes both object volumetric data 201 and air volumetric data 202. In an embodiment, the sampling of the voxels comprising the x-ray image is performed by a computer processor. By way of example, if the original x-ray image may include millions of voxels (3D image), the sampling may analyze about a specified small percentage of voxels to determine which of the sampled voxels have values exceeding a predetermined value of a voxel threshold. The voxels 601, 602, and 603, positioned within the object volumetric data 201 are darkened (for purposes of illustration only) to indicate that their values exceeded a predetermined voxel threshold during the sampling of the image volumetric data. In contrast, the voxels comprising the air volumetric data 202 are not darkened to indicate that their values have not exceeded the predetermined voxel threshold during the sampling of the image volumetric data.

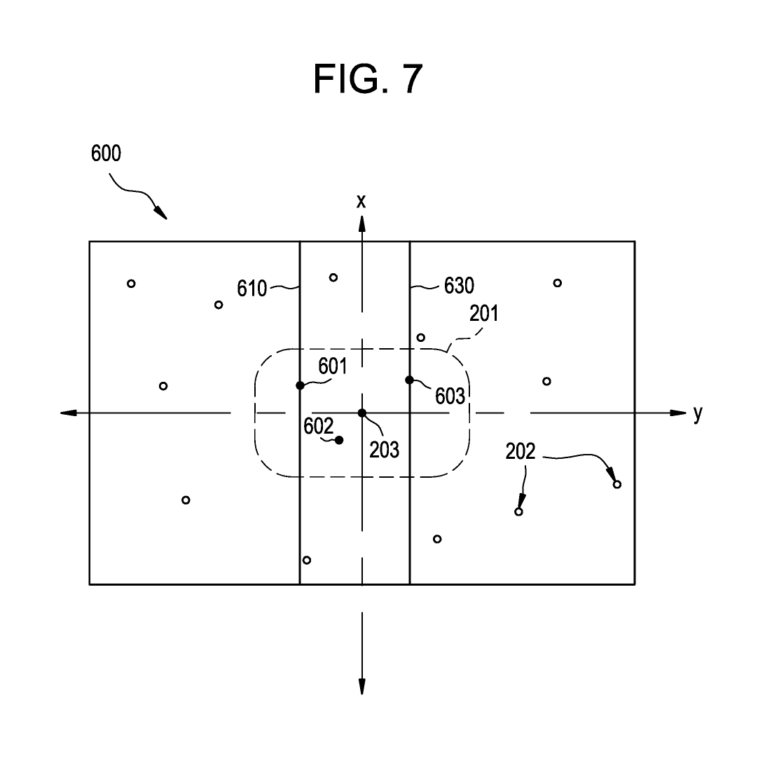

Referring to FIG. 7, once the voxels 601, 602, 603 with values exceeding the predetermined voxel threshold have been identified by a computer processor from the sampled image data, their locations are compared with the location of the origin 203 to determine which of the voxels 601, 602, 603 are furthest from the origin 203 in the positive (+) and negative (−) X, Y, and Z directions. As shown in FIG. 7, voxel 601 is furthest from the origin 203 in the negative Y direction, while voxel 603 is furthest from the origin 203 in the positive Y direction. Accordingly, a computer processor forms a first slice 610 through the voxel 601 and parallel the X axis. The computer processor also forms a second slice 630 through the voxel 603 and parallel the X axis.

Referring to FIG. 8, the slice 610 is iterated, at least one voxel-width at a time, from its original position “A” along the negative Y axis away from the origin 203 towards a second position “B.” Similarly, the slice 630 is iterated, at least one voxel-width at a time, from its original position “C” along the positive Y axis away from the origin 203 towards a second position “D.” At each iteration, the computer processor searches the slice 610,630 for one or more voxels that exceed the predetermined voxel threshold by a predetermined amount. When an iterated slice does not contain one or more voxels that exceed the predetermined voxel threshold by a predetermined amount, that iterated slice (610 at position “B,” 630 at position “D”) is set as a component of a bounding box. In this example, a y-value of the iterated slice 610 at position “B” is stored in a computer readable memory as a “Minimum Y” value of a bounding box (204 shown in FIG. 11). In like manner, the Y-value of the iterated slice 630 at position “D” is stored in the computer readable memory as a “Maximum Y” value of the bounding box 204.

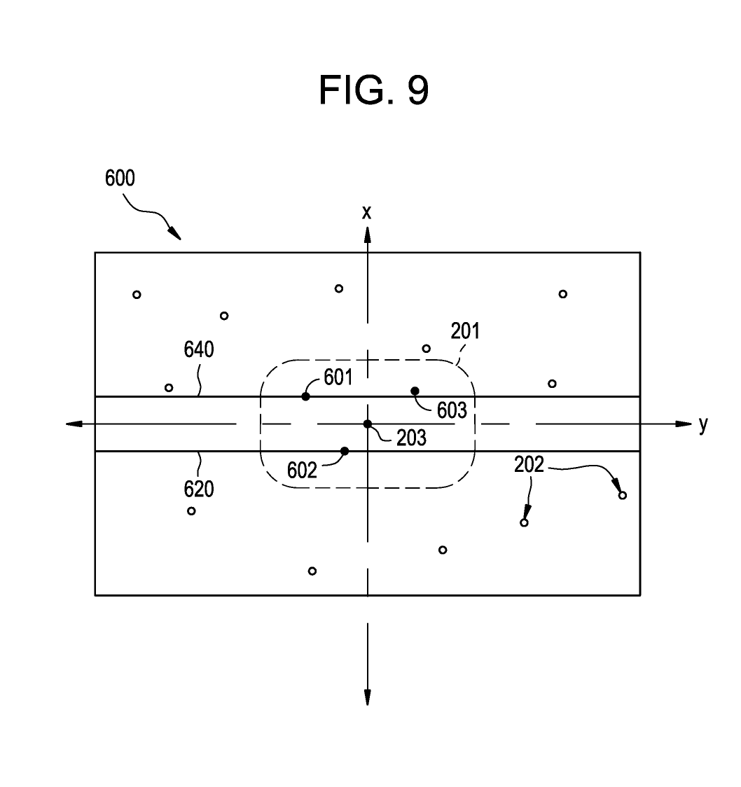

Referring to FIG. 9, voxel 602 is furthest from the origin 203 in the negative X direction, while voxel 603 is furthest from the origin 203 in the positive X direction. Accordingly, a computer processor forms a first slice 620 through the voxel 602 and parallel the Y axis. The computer processor also forms a second slice 640 through the voxel 603 and parallel the Y axis.

Referring to FIG. 10, the slice 620 is iterated, at least one voxel-width at a time, along the negative X axis from its original position “E,” and away from the origin 203, towards a second position “F.” Similarly, the slice 640 is iterated, at least one voxel-width at a time, along the positive X axis from its original position “G,” and away from the origin 203, towards a second position “H.” At each iteration, the computer processor searches the slice 620,640 for one or more voxels that exceed the predetermined voxel threshold by a predetermined amount. When an iterated slice does not contain one or more voxels that exceed the predetermined voxel threshold by a predetermined amount, the iterated slice (620 at position “F,” 640 at position“H”) is set as a component of the bounding box. In this example, an X-value of the iterated slice 620 at position “F” is stored in a computer readable memory as a “Minimum X” value of a bounding box (204 shown in FIG. 1 1). In like manner, the X-value of the iterated slice 640 at position “H” is stored in the computer readable memory as a “Maximum X” value of the bounding box 204.

As mentioned above with respect to steps 320-327 of the method 300, the processes of forming slices, iterating slices, and storing minimum and maximum axis values are repeated in Z (not shown).

FIG. 11 illustrates a two-dimensions of a three-dimensional bounding box 204. In FIG. 11, the bounding box 204 is formed by the intersecting slices 610, 620, 630, and 640. Although not shown, the bounding box 204 further includes an intersecting slice having a “Maximum Z” value and an intersecting slice having a “Minimum Z value.” The interior of the bounding box 204 contains the object volumetric data 201 and/or a small amount of air volumetric data 205. The computer processor uses the (three-dimensional) bounding box 204 to crop other air volumetric data 202, which is external to the bounding box 204, from the image data. After the cropping, only the object volumetric data 201 and/or a negligible amount of air volumetric data 205 remain. The image data defined by the bounding box 204 is stored in a computer-readable memory and further processed and/or analyzed by the computer processor to determine whether the object volumetric data 201 indicates the presence of one or more alarm objects. Optionally, the attained object volumetric data 201 may be displayed on a display device for viewing by an operator of the imaging system (and/or an explosive detection system of which the imaging system is part).

A detailed description of various embodiments of the claimed invention has been provided; however, modifications within the scope of the claimed invention will be apparent to persons having ordinary skill in the above-referenced technological field. Such persons will appreciate that features described with respect to one embodiment may be applied to other embodiments. Thus, the scope of the claimed invention is to be properly construed with reference to the following claims.

What is claimed is:

1. A method, comprising:
obtaining image data of an object from an imaging system, wherein the image data comprises air volumetric data and object volumetric data;
sampling the image data in three dimensions;
identifying one or more candidate voxels; and
identifying, from the one or more candidate voxels, one or more starting voxels.

2. The method of claim 1, wherein each of the one or more starting voxels is identified based on one of a maximum and minimum coordinate in three dimensions.

3. The method of claim 1, wherein the step of identifying one or more candidate voxels further comprises:
comparing values of voxels that comprise the sampled image data with a predetermined voxel threshold.

4. The method of claim 1, wherein the step of sampling the image data in three dimensions occurs randomly.

5. The method of claim 1, further comprising:
creating at least one slice through at least one of the one or more starting voxels.

6. The method of claim 5, wherein the at least one slice is orthogonal to a coordinate selection axis of the at least one of the one or more starting voxels.

7. The method of claim 1, further comprising:
storing, in a computer readable memory, coordinates of the one or more starting voxels.

8. The method of claim 5, further comprising:
iterating the at least one slice, at least one voxel width at a time, in one of a positive and a negative direction, along an axis that is orthogonal to it.

9. The method of claim 8, further comprising:
searching within the at least one iterated slice for a predetermined number of voxels, each of whose values exceed the predetermined voxel threshold.

10. The method of claim 9, further comprising:
marking, as a surface of a bounding box, each iterated slice that contains no voxels having values that exceed the predetermined voxel threshold or that contains less than the predetermined number of voxels having values that exceed the predetermined voxel threshold.

11. The method of claim 1, further comprising:
processing object volumetric data within the bounding box for a presence of an alarm object.

12. The method of claim 1, wherein the imaging system is an x-ray CT scanner.

13. The method of claim 1, wherein the imaging system is integrated with an explosive detection system.

14. A system, comprising:
an imaging system configured to obtain image data of an object, wherein the image data comprises air volumetric data and object volumetric data;
a computer processor coupled with the imaging system;
a memory readable by the computer processor; and
computer executable instructions stored in the memory, that when executed by the computer processor cause the computer processor to:
operate the imaging system to obtain the image data of the object;
sample the image data in three dimensions;
identify one or more candidate voxels; and
identify, from the one or more candidate voxels, one or more starting voxels.

15. The system of claim 14, wherein each of the one or more starting voxels is identified based on one of a maximum and minimum coordinate in three dimensions.

16. The system of claim 14, wherein the computer executable instructions, when executed by the computer processor, further cause the computer processor to:
compare values of voxels that comprise the sampled image data with a predetermined voxel threshold.

17. The system of claim 14, wherein the computer executable instructions, when executed by the computer processor, further cause the computer processor to sample the image data in three dimensions randomly.

18. The system of claim 1, wherein the computer executable instructions, when executed by the computer processor, further cause the computer processor to:
create at least one slice through at least one of the one or more starting voxels.

19. The system of claim 18, wherein the at least one slice is orthogonal to a coordinate selection axis of the at least one of the one or more starting voxels.

20. The system of claim 18, wherein the computer executable instructions, when executed by the computer processor further cause the computer processor to:
iterate the at least one slice, at least one voxel width at a time, in one of a positive and a negative direction, along an axis that is orthogonal to it.

21. The system of claim 20, wherein the computer executable instructions, when executed by the computer processor further cause the computer processor to:
search within the iterated slice for a predetermined number of voxels, each of whose values exceeds the predetermined voxel threshold.

22. The system of claim 21, wherein the computer executable instructions, when executed by the computer processor further cause the computer processor to:
mark, as a surface of a bounding box, the iterated slice that contains no voxels having values that exceed the predetermined voxel threshold or that contains less than a predetermined number of voxels having values that exceed the predetermined voxel threshold.

23. The system of claim 22, wherein the computer executable instructions, when executed by the computer processor further cause the computer processor to:
process object volumetric data within the bounding box for a presence of an alarm object.

24. The system of claim 1, wherein the imaging system is integrated with an explosive detection system.
